(19) United States
(12) Patent Application Publication
(10) Pub. No.: US 2011/0176058 A1
(43) Pub. Date: Jul. 21, 2011

(54) USE OF FILM GRAIN TO MASK COMPRESSION ARTIFACTS

(76) Inventors: Mainak BISWAS, Santa Cruz, CA (US); Nikhil BALRAM, Mountain View, CA (US)

(21) Appl. No.: 13/006,805

(22) Filed: Jan. 14, 2011

Related U.S. Application Data
(60) Provisional application No. 61/295,340, filed on Jan. 15, 2010.

(51) Int. Cl. H04N 9/64; H04N 5/14

(52) U.S. Cl. 348/577; 348/576; 348/E09.037; 348/E05.062

(57) ABSTRACT

Systems, methods, and other embodiments associated with processing video data are described. According to one embodiment, a device comprises a video processor for processing a digital video stream by at least identifying a facial boundary within images of the digital video stream. A combiner selectively applies a digital film grain to the images based on the facial boundary.

### CROSS REFERENCE TO RELATED APPLICATIONS

This application claims the benefit of U.S. provisional application Ser. No. 61/295,340 filed on Jan. 15, 2010, which is hereby wholly incorporated by reference.

### BACKGROUND

Bandwidth limitations in storage devices and/or communication channels require that video data be compressed. Compressing video data contributes to the loss of detail and texture in images. The higher the compression rate, the more content is removed from the video. For example, the amount of memory required to store an uncompressed 90-minute long moving picture feature film (e.g. a movie) is often around 90 Gigabytes. However, DVD media typically has a storage capacity of 4.7 Gigabytes. Accordingly, storing the complete movie onto a single DVD requires high compression ratios of the order of 20:1. The data is further compressed to accommodate audio on the same storage media. By using the MPEG2 compression standard, for example, it is possible to achieve the relatively high compression ratios. However, when the movie is decoded and played back, compression artifacts like blockiness and mosquito noise are often visible. Numerous types of spatial and temporal artifacts are characteristic of transformed compressed digital video (i.e., MPEG-2, MPEG-4, VC-1, WM9, DIVX, etc.). Artifacts can include contouring (particularly noticeable in smooth luminance or chrominance regions), blockiness, mosquito noise, motion compensation and prediction artifacts, temporal beating, and ringing artifacts.

After decompression, the output of certain decoded blocks makes surrounding pixels appear averaged together and look like larger blocks. As display devices and televisions get larger, blocking and other artifacts become more noticeable.

### SUMMARY

In one embodiment, a device comprises a video processor for processing a digital video stream by at least identifying a facial boundary within images of the digital video stream. The device also comprises a combiner to selectively apply a digital film grain to the images based on the facial boundary.

In one embodiment, an apparatus comprises a film grain generator for generating a digital film grain. A face detector is configured to receive a video data stream and determine a face region from images in the video data stream. A combiner applies the digital film grain to the images in the video data stream within the face region.

In another embodiment, a method includes processing a digital video stream by at least defining a face region within images of the digital video stream; and modifying the digital video stream by applying a digital film grain based at least in part on the face region.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one example of the boundaries. In some examples one element may be designed as multiple elements or that multiple elements may be designed as one element. In some embodiments, an element shown as an internal component of another element may be implemented as an external component and vice versa. Furthermore, elements may not be drawn to scale.

FIG. 1 illustrates one embodiment of an apparatus associated with processing digital video data.

FIG. 2 illustrates another embodiment of the apparatus of FIG. 1.

FIG. 3 illustrates one embodiment of a method associated with processing digital video data.

### DETAILED DESCRIPTION

In the process of video compression, decompression, and removal of compression artifacts, the video stream can often lose a natural-looking appearance and instead can acquire a patchy appearance. By adding an amount of film grain (e.g. noise), the video stream can be made to look more natural and more pleasing to a human viewer. Addition of film grain may also provide a more textured look to patchy looking areas of the image. When a video stream goes through extensive compression, it can lose much detail in places where there should be texture such as a human face. Typically, the compression process can cause the image in the facial region to look flat and thus unnatural. Applying a film grain to the facial regions may reduce the unnatural look.

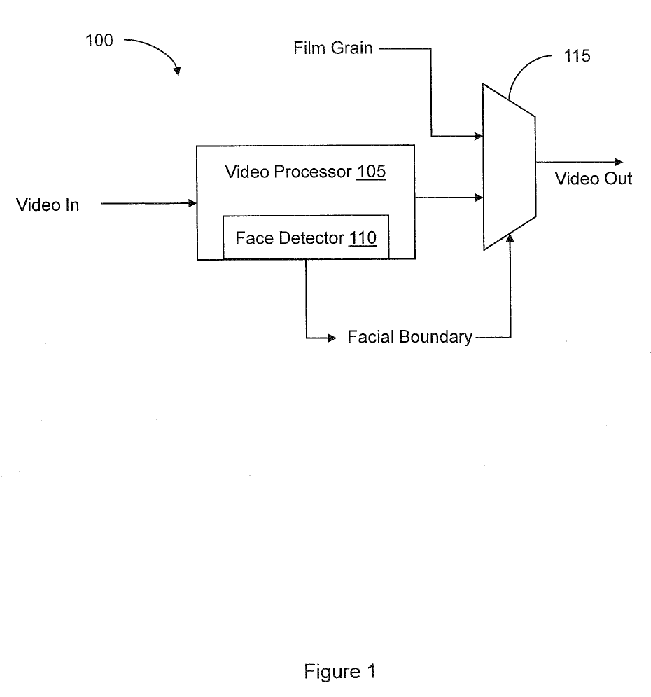

Illustrated in FIG. 1 is one embodiment of an apparatus 100 that is associated with using film grain when processing video signals. As an overview, the apparatus 100 includes a video processor 105 that processes a digital video stream (video In). In this example, it is assumed that the video stream was previously compressed and decompressed prior to reaching the video processor. A face detector 110 analyzes the video stream to identify facial regions in the images of the video. For example, a facial region is an area in an image that corresponds to a human face. A facial boundary may also be determined that defines the perimeter of the facial region. In one embodiment, the perimeter is defined by pixels located along the edges of the facial region. A combiner 115 then selectively applies a film grain to the video stream based on the facial boundary. In other words, the film grain is applied to pixels within the facial boundary (e.g., applied to pixels in the facial region). By adding a film grain, facial regions may appear to look more natural rather than appearing unnaturally flat due to compression artifacts. In one embodiment, the film grain is selectively applied by targeting only facial regions and not applying the film grain to other areas as determined by the facial boundaries/regions identified.

In some embodiments, the apparatus 100 can be implemented in a video format converter that is used in a television, a blue ray player, or other video display device. The apparatus 100 can also be implemented as part of a video decoder for video playback in a computing device for viewing video downloaded from a network. In some embodiments, the apparatus 100 is implemented as an integrated circuit.

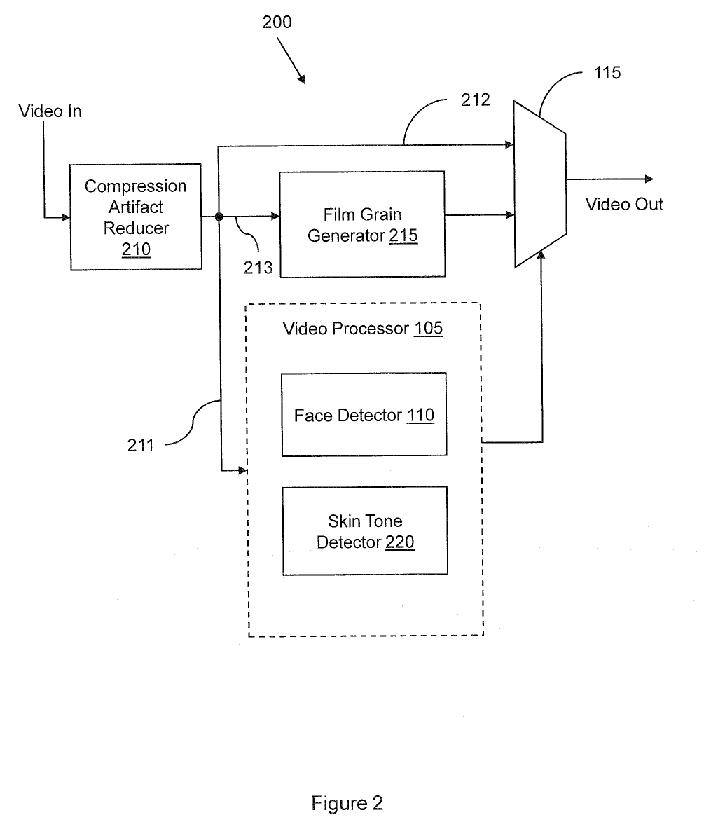

With reference to FIG. 2, another embodiment of an apparatus 200 is shown that includes the video processor 105. The input video stream may first be processed by a compression artifact reducer 210 to reduce compression artifacts that appear in the video images. As stated previously, it is assumed the video stream was previously compressed and decompressed. The video stream is output along signal paths 211, 212, and 213, to the video processor 105, the combiner 115, and a film grain generator 215, respectively. As explained above, the facial boundary generated by the video processor 105 controls the combiner 115 to apply the film grain from the film grain generator 215 to the regions in the video stream within the facial boundary. Of course, multiple facial boundaries may be identified for images that include multiple faces.

With regard to the compression artifact reducer 210, in one embodiment the compression artifact reducer 210 receives the video data stream in an uncompressed form and modifies the video data stream to reduce at least one type of compression artifact. For example, certain in-loop and post-processing algorithms can be used to reduce blockiness, mosquito noise, and/or other types of compression artifacts. Blocking artifacts are distortion that appears in compressed video signals as abnormally large pixel blocks. Also called “macroblocking,” it may occur when a video encoder cannot keep up with the allocated bandwidth. It is typically visible with fast motion sequences or quick scene changes. When using quantization with block-based coding, as in JPEG-compressed images, several types of artifacts can appear such as ringing, contouring, posterizing, staircase noise along curving edges, blockiness in “busy” regions (sometimes called quilting or checkerboarding), and so on. Thus one or more artifact reducing algorithms can be implemented. The particular details of the artifact reducing algorithm that may be implemented with the compression artifact reducer 210 are beyond the scope of the present disclosure and will not be discussed.

With continued reference to FIG. 2, along with the face detector 110, the video processor 105 includes a skin tone detector 220. In general, the face detector 110 is configured to identify areas that are associated with a human face. For example, certain facial features may be located, if possible, such as eyes, ears, and/or mouth to assist in identifying areas of a face. A bounding box is generated that defines a facial boundary of where the face might be. In one embodiment, preselected tolerances may be used to expand the bounding box certain distances from the identified facial features as is expected from typical human head sizes. The bounding box is not necessarily limited to a box shape but may be a polygon, circle, oval, or other curved or angled edges.

The skin tone detector 220 performs pixel value comparisons that try to identify pixel values that resemble skin tone colors within the bounding box. For example, preselected hue and saturation values that are associated with known skin tone values can be used to locate skin tones in and around the area of the facial bounding box. In one embodiment, multiple iterations of pixel value comparisons may be performed around the perimeter of the bounding box to modify its edges to more accurately find the boundary of the face. Thus the results from the skin tone detector 220 are combined with the results of the face detector 110 to modify/adjust the bounding box of the facial region. The combined results may provide a better classifier of where a face should be in an image.

In one embodiment, the combiner 115 then applies a digital film grain to the video stream within areas defined by the facial bounding box. For example, the combiner 115 generates masks values using the film grain that are combined with the pixel values within the facial bounding box. In one embodiment, the combiner 115 is configured to apply the digital film grain to red, green, and blue channels in the video data stream. Areas outside the facial bounding box are bypassed (e.g. film grain is not applied). In this manner, the visual appearance of faces in the video may look more natural and have more texture.

With continued reference to FIG. 2, the film grain generator 215 is configured to generate the digital film grain for application to the video stream. In one embodiment, the film grain is generated dynamically (on-the-fly) based on the current pixel values found in the facial regions. Thus the film grain is correlated with the content of the facial region and is colored (e.g., a skin tone film grain). For example, the film grain is generated using red, green, and blue (RGB) parameters from the facial region and are then modified, adjusted, and/or scaled to produce noise values.

In one embodiment, the film grain generator 215 is configured to control grain size and the amount of film grain to be added. For example, digital film grain is generated that is two or more pixels wide and has particular color values. The color values may be positive or negative. In general, the film grain generator 215 generates values that represent noise with skin tone values, which are applied to the video data stream within the facial regions.

In another embodiment, the film grain may be generated independently (randomly) from the video data stream (e.g. not dependent upon current pixel values in the video stream). For example, pre-generated skin tone values may be used as noise and applied as the film grain.

In one embodiment, the film grain is generated as noise and is used to visually mask (or hide) video artifacts. In the present case, the noise is applied to facial regions of images as controlled by the facial bounding box determined by the face detector 110. Two reasons to add some type of noise to video for display are to mask digital encoding artifacts, and/or to display film grain as an artistic effect.

Film grain noise is considered less structured as compared to structured noise that is characteristic of digital video. By adding some amount of film grain noise, the digital video can be made to look more natural and more pleasing to the human viewer. The digital film grain is used to mask unnatural smooth artifacts in the digital video.

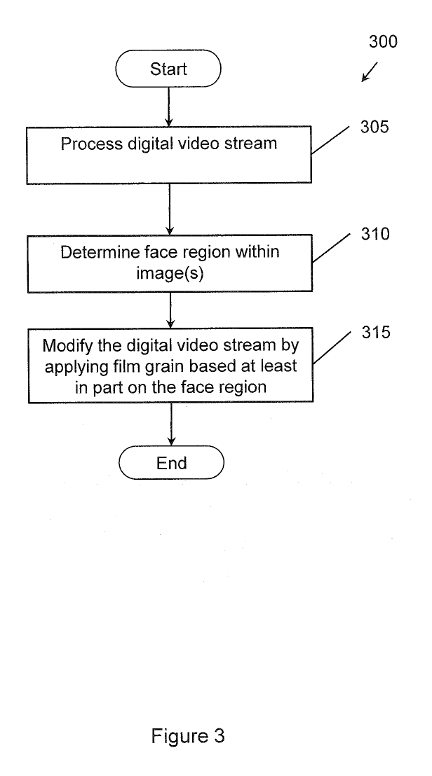

With reference to FIG. 3, one embodiment of a method 300 is shown that is associated with processing video data as described above. At 305, the method 300 processes a digital video stream. At 310, one or more face regions are determined from the video. In one embodiment, a facial boundary is identified and defined for each face within the image(s) to define the corresponding face region. At 315, the digital video stream is modified by applying film grain to the video data based at least in part on the defined face region (or boundaries). For example, using the face region and/or identified facial boundaries as input, the film grain is applied to pixel values that are within the face region. Various ways to generate the film grain, its size, and color can be performed as described previously. In another embodiment, the facial boundary is adjusted by performing a skin tone analysis as described previously. In this manner, the area that defines the facial region is adjusted with the film grain.

Accordingly, the systems and methods described herein use noise values that have the visual property of film grain and apply the noise to facial regions in a digital video. The noise masks unnatural smooth artifacts like “blockiness” and “contouring” that may appear in compressed video. Traditional film generally produces a more aesthetically pleasing look than digital video, even when very high-resolution digital sensors are used. This “film look” has sometimes been described as being more “creamy and soft” in comparison to the more harsh, flat look of digital video. This aesthetically pleasing property of film results (at least in part) from the randomly occurring, continuously moving high frequency film grain as compared to the fixed pixel grid of a digital sensor.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Logic”, as used herein, includes but is not limited to hardware, firmware, instructions stored on a non-transitory medium or in execution on a machine, and/or combinations of each to perform a function(s) or an action(s), and/or to cause a function or action from another logic, method, and/or system. Logic may include a software controlled microprocessor, a discrete logic (e.g., ASIC), an analog circuit, a digital circuit, a programmed logic device, a memory device containing instructions, and so on. Logic may include one or more gates, combinations of gates, or other circuit components. Where multiple logics are described, it may be possible to incorporate the multiple logics into one physical logic. Similarly, where a single logic is described, it may be possible to distribute that single logic between multiple logics. One or more of the components and functions described herein may be implemented using one or more logic elements.

While for purposes of simplicity of explanation, illustrated methodologies are shown and described as a series of blocks. The methodologies are not limited by the order of the blocks as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional, not illustrated blocks.

To the extent that the term “includes” or “including” is employed in the detailed description or the claims, it is intended to be inclusive in a manner similar to the term “comprising” as that term is interpreted when employed as a transitional word in a claim.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the disclosure is not limited to the specific details, the representative apparatus, and illustrative examples shown and described. Thus, this application is intended to embrace alterations, modifications, and variations that fall within the scope of the appended claims.

What is claimed is:

1. A device comprising:
a video processor for processing a digital video stream by at least identifying a facial boundary within images of the digital video stream; and
a combiner to selectively apply a digital film grain to the images based on the facial boundary.

2. The device of claim 1, wherein the combiner is configured to apply the digital film grain to red, green, and blue channels in the digital video stream.

3. The device of claim 1, further comprising a film grain generator for generating the digital film grain that is correlated to colors of pixels values within the facial boundary.

4. The device of claim 1, wherein the combiner is configured to modify the images by combining the digital film grain with pixel values that are within the facial boundary, and without applying the digital film grain to areas outside the facial boundary.

5. The device of claim 1, further comprising a film grain generator for generating the digital film grain with a size being greater-than-one pixel wide.

6. The device of claim 1, where the video processor comprises:
a skin tone detector for determining skin tone values from pixels in the images to identify portions of a face that are associated with a facial region; and
a face detector configured to determine the facial boundary, which is a boundary of the facial region, where the facial boundary is adjusted based at least in part on the skin tone values.

7. An apparatus, comprising:
a film grain generator for generating a digital film grain;
a face detector configured to receive a video data stream and determine a face region from images in the video data stream; and
a combiner to apply the digital film grain to the images in the video data stream within the face region.

8. The apparatus of claim 7, wherein the apparatus is configured to apply the film grain to red, green, and blue channels in the video data stream.

9. The apparatus of claim 7, wherein the film grain generator is configured to generate the digital film grain using red, green, and blue parameters from the video data stream.

10. The apparatus of claim 7, wherein the film grain generator is configured to generate a mask of noise values that are correlated to pixel values of the video data stream, where the mask represents the digital film grain.

11. The apparatus of claim 7, where the face detector is configured to generate a bounding box that represents a boundary of the face region within an image; and
where the combiner applies the digital film grain based on the bounding box.

12. The apparatus of claim 7, where the face detector comprises:
a skin tone detector for determining skin tone values from pixels in the images to identify portions of a face; and
where the face detector is configured to determine a boundary of the face region, where the boundary is adjusted based at least in part on the skin tone values.

13. The apparatus of claim 7, where the combiner is configured to apply the digital film grain to the images within the face region without applying the digital film grain to areas outside the face region.

14. The apparatus of claim 7, further comprising a compression artifact reducer configured to:
receive the video data stream in an uncompressed form;
modify the video data stream to reduce at least one type of compression artifact; and
where the apparatus includes signal paths to output the modified video stream to the film grain generator, to the face detector, and to the combiner.

15. A method, comprising:
processing a digital video stream by at least defining a face region within images of the digital video stream; and
modifying the digital video stream by applying a digital film grain based at least in part on the face region.

16. The method of claim 15, wherein the film grain includes color values that are applied to red, green, and blue channels in the video data stream.

17. The method of claim 15, further comprising generating the digital film grain using skin tone values from pixel values from video data stream that are within the face region.

18. The method of claim 15, where the digital film grain is applied to the images within the face region without applying the digital film grain to areas outside the face region.

19. The method of claim 15, further comprising generating the digital film grain from skin tone color values.

20. The method of claim 15, where defining the face region comprises:
determining skin tone values from pixels in the images to identify portions of a face; and
adjusting a boundary of the face region based at least in part on the skin tone values.
